(19) United States
(12) Patent Application Publication
(10) Pub. No.: US 2003/0014288 A1
(43) Pub. Date: Jan. 16, 2003

(54) System and method for managing transportation demand and capacity

(76) Inventors: Lloyd Clarke, Green Bay, WI (US); A. Bruce Gamble, Green Bay, WI (US); Jennifer Jancik-Bailey, De Pere, WI (US); Ryan Orchard, Edmonton (CA)

Correspondence Address: SWIDLER BERLIN SHEREFF FRIEDMAN, LLP, 3000 K STREET, NW, BOX IP, WASHINGTON, DC, 20007, US

(21) Appl. No.: 09/902,577

(22) Filed: Jul. 12, 2001

(51) Int. Cl. G06F 17/00; G06F 17/60

(52) U.S. Cl. 705/7; 705/400

(57) ABSTRACT

The present invention comprises a system and method for managing transportation demand and capacity. The present invention allows a carrier to perform rapid and accurate determinations of the profitability of accepting various load transporting opportunities while taking into account the effect of taking a particular load on the entire carrier network. The present invention makes these profitability determinations based on a network model which is continually updated to account for changing market conditions and the effects of real-time events. The method of the present invention includes creating a dynamic network flow model comprised of multiple nodes, each node representing a specific location at specific time. The marginal value of a unit of capacity (e.g. a truck, a trailer, a rail car, a plane, etc.) at each node is calculated by solving the dual of a linear program associated with the network flow model. A matrix is created by a dynamic network value engine (NVE). The matrix contains a marginal value for a unit of capacity for each node in the network flow model up to some predetermined time in the future. The profitability of transporting a given load from a source node to a destination node is made based on the revenue minus the cost plus the marginal value of a unit of capacity at the destination node minus the marginal value of a unit of capacity at the source node. The marginal value of a unit of capacity at a given node is obtained from the matrix. The dynamic NVE periodically and continually updates the matrix to account for changing market conditions. Transportation decisions are then made based upon the profitability determinations.

The present invention also includes a “webcrawler” feature. The webcrawler searches a database offers by shippers to have loads shipped. The webcrawler determines the profitability of each offer and prioritizes the offers based on profitability.

### BACKGROUND OF THE INVENTION

The truckload industry is highly competitive with very thin profit margins. In such an industry, it is critically important that a company fully understand the potential profitability (or lack thereof) of every piece of business that comes its way. Current methods for evaluating profitability are cumbersome and don't accurately account for real-time events and current market conditions. What is needed is a tool that allows a truckload company or any other type of carrier to quickly and accurately calculate an estimated profit of a given load, taking into account all effects on the carrier's surrounding network.

### SUMMARY OF THE INVENTION

The present invention comprises a system and method for managing transportation demand and capacity. The present invention allows a carrier to perform rapid and accurate determinations of the profitability of accepting various load transporting opportunities while taking into account the effect of taking a particular load on the entire carrier network. The present invention makes these profitability determinations based on a network model which is continually updated to account for changing market conditions and the effects of real-time events.

The method of the present invention includes creating a dynamic network flow model comprised of multiple nodes, each node representing a specific location at specific time. The marginal value of a unit of capacity (e.g. a truck, a trailer, a rail car, a plane, etc.) at each node is calculated by solving the dual of a linear program associated with the network flow model. A matrix is created by a dynamic network value engine (NVE). The matrix contains a marginal value for a unit of capacity for each node in the network flow model up to some predetermined time in the future. The profitability of transporting a given load from a source node to a destination node is made based on the revenue minus the cost plus the marginal value of a unit of capacity at the destination node minus the marginal value of a unit of capacity at the source node. The marginal value of a unit of capacity at a given node is obtained from the matrix. The dynamic NVE periodically and continually updates the matrix to account for changing market conditions. Transportation decisions are then made based upon the profitability determinations.

Each node in the network is connected by an arc. The arc has an associated variable representing the number of units of capacity to be moved between the connected nodes. The network flow model includes constraints at each node representing conservation of flow.

Each arc has an upper bound representing the demand for loads to be transported between the source node and the destination node, and the arc has a lower bound representing commitments for loads to be transported between the source node and the destination node. The demand for loads to be transported on a particular arc is determined by demand forecasting based on historical data. Each arc has an associated average revenue and average cost. Two nodes can also be connected by multiple arcs, each arc having an associated revenue and an associated cost.

A holistic model can also be used. The holistic network flow model does not have different nodes for different times, but only includes a single node for each location. The holistic model is simpler because it doesn't take into account changing conditions over time. The holistic model provides a simpler, less computationally intensive model that can be useful as a scenario evaluator for decision making on contracted pricing and other long-term decision making. Both the holistic and dynamic models can be used not only for making current transportation decisions, but they also can double as scenario testers to help answer a range of longer-term tactical and strategic questions.

The profitability determinations can be used to make a variety of load transportation decisions such as a) deciding whether or not to accept an offer to transport a load at a specified contracted price over a specified time period; b) prioritizing a plurality of offers to transport loads based on profitability; c) determining a contracted price to offer for transporting a load; d) determining a price to offer a shipper, for soliciting the shipper to transport a load by an idle unit of capacity; e) determining a spot price for transporting a load; f) selecting a mode of one of solo, team, rail, third party, regional or Canadian; and g) assigning a specific unit of capacity and a specific driver to a particular load.

The present invention also includes a “webcrawler” feature. The webcrawler searches a database offers by shippers to have loads shipped. The webcrawler determines the profitability of each offer and prioritizes the offers based on profitability. The webcrawler can also spider into business-to-business databases connected to the world wide web, and find the best offers.

### BRIEF DESCRIPTION OF THE DRAWINGS

FIG. 1 illustrates a block diagram depicting the network value engine and order process of the present invention.

### DETAILED DESCRIPTION OF THE INVENTION

The following terminology will be used herein. A “carrier” is a company in the business of transporting goods. For example, the carrier may own trucks, trailers, rail cars, airplanes, and so forth. A “shipper” is a customer who has a load that needs to be shipped and wants the carrier to ship the load from point A to point B. For example, the shipper could be a large retailer or chain of supermarkets. Although many examples will be given below with regards to the trucking industry, the present invention is not limited to the truckload industry but can be used by any carrier in the business of transporting goods, people, or any other item. Lastly, a “lane” refers to a particular shipment route, for example, Denver-to-Los Angeles represents one particular “lane.”

The standard definition of profit is simply total revenue minus total cost. In the truckload industry, however, there is an additional complication. The complication is the fact that moving freight from Point A to Point B also moves a unit of capacity (e.g. a truck, a rail car, a trailer, a plane etc.) from Point A to Point B. Thus, when evaluating the profitability of moving a load from Atlanta to Baltimore, not only must the direct revenues and costs be considered, but also the difference in value of having an extra truck in Baltimore vs. having an extra truck in Atlanta. Therefore, to determine the profitability of moving a load from A to B, the following equation must be used:

Profitability of a load AB from A to B=Revenue (AB)−Cost (AB)−Val (A)+Val (B)

where Val(i) is an estimate of the marginal value of having a truck at location i.

In order for the carrier to make wise decision making regarding which loads to ship and how much to charge, the carrier needs to have a fast and accurate method of determining the profitability of transporting a particular load according to the above equation. Determining direct revenue and cost is relatively straightforward. Therefore, determining the value of a load can be reduced to the problem of determining the marginal value of a unit of capacity in a given location, Val(i). The truckload industry today uses a crude static model to determine the marginal value of a unit of capacity. The static model, described below, evaluates the value of the load in isolation from its impact on the overall network. After the static model is described, two improved models for determining Val(i) will be described, the dynamic and holistic models, which provide a better determination of marginal value because they take into accept a load's effect on the entire network.

1. Static Model

A first way of determining the marginal value of a unit of capacity is a simple static model. The static model allows “static” marginal values Val (A) and Val (B) to be calculated. With the static model, each load is evaluated in isolation from its impact on the overall network. Static marginal values Val(A) and Val(B) are estimated by looking historically at the amount of profit generated by the average truck after arriving at location B.

For example, the static model evaluates the historical data showing the profits earned by trucks in the past when leaving a location B. The static model determines the average amount of profit generated by a truck, after leaving a location B over the past month or the past quarter (or any desired time period). For example, one data point might show that one truck departed from B carrying a load to B′ and obtained a profit of X. A second truck carried a load from B to B″ and earned a profit of Y. All of these profits can be averaged over a desired time period to determine an average profitability of a truck at location B; this in turn determines Val(B), the marginal value of a truck at location B. Alternatively, the marginal value Val (B) could be assigned to be equal to the average profit of the next 2 loads of a truck after leaving location B, or the next 3 loads, or any desired number of loads after leaving location B.

The static model has the advantage that the marginal values are easy to calculate if there is existing historical data (no optimization algorithms are required). The disadvantage of the static model is that it is a relatively crude method for calculating marginal values Val(A) and Val(B), and does not take into account current market conditions or the load's impact on the entire network.

2. Dynamic and Holistic Models

The dynamic model uses linear programming to evaluate a load's impact on the entire network. The dynamic model is a time-phased network flow model. The network flow model is comprised of nodes, each node representing a particular location at a particular time. As an example of a network flow model, suppose one node represents the city of Denver at 9:00 am on Thursday, Jul. 5, 2001. There is also a node representing Chicago at the same date and time, another node at Denver, another node at Los Angeles, and so forth. At 1:00 pm on the same day, there could be a new set of nodes for each of these locations. A truck leaving New York City at 9:00 am and arriving in Washington D.C. at 1:00 pm would be traveling from a source node representing Washington D.C. at 9:00 am and arriving at a destination node representing New York City at 1:00 pm. The time spacing between nodes is a matter of design choice. For example, the nodes could be separated by 4 hours, by 12 hours, by 1 day, by 1 month, by 1 year, etc.

All of the nodes are connected by arcs. Each arc represents a feasible lane from an origin node at a given time, to a destination node at another given time. Each arc has a variable associated with the arc. The variable for the arc represents flow, the number of trucks to be moved on that lane during that time period. The linear program includes constraints at each node. The constraints represent conservation of flow. The flow into each node must equal the flow out. Arc upper bounds represent the total available freight (i.e. the total demand for loads to be shipped) for that arc. The arc lower bounds represent commitments; i.e. freight that the carrier has already agreed to ship. Each arc has an associated average revenue and average cost. By solving the linear program, the optimal values of the variables can be determined. The optimal values of the variables represent the number of loads to ship for each arc to maximize profits, subject to the constraints.

Associated with any linear program is another linear program, called the dual. When taking the dual of a given linear program, the given linear program is referred to as the primal. If the primal is a max problem, the dual will be a min problem, and vice versa.

The dual of the primal linear program described above is determined. Each dual variable corresponds to a constraint in the primal linear program. The dual variables represent the value of adding capacity to that constraint. In other words, by solving the dual LP, the marginal value of a unit of capacity at a specific location at a specific time is determined.

As mentioned, the upper bounds on each arc represent the total demand. These demand values must be determined by forecasts of the demand. The demand for a particular lane at a particular time is forecasted taking into account historical data, holiday effects, and other known patterns or variation in demand over time. For example, automobile manufacturers in Michigan have a shut down every year in the summertime when they do the model year changeover. All of the lines shut down for a time, so suddenly there's very little demand. Factors such as this shutdown should thus be accounted for in the demand forecast.

Each arc in the network flow model can potentially be split into multiple arcs representing different revenue and cost buckets. For example, suppose that there is one arc going from Denver to LA, and a carrier has committed to move at least ten loads. There is a total demand of 20 loads forecasted. Therefore, the carrier can move between ten and twenty loads on that arc. Now, if only a single arc is used, then the goal is to maximize the average revenue minus cost on that arc. However, if the carrier has different customers with very different revenues, the model could include two different arcs representing two different customers, with upper and lower bounds on each of those arcs. Suppose that the carrier is committed to transport five loads for each customer and might get up to as many as ten loads for each customer. However, one customer provides $1.00/mile and the other customer provides $1.30 per mile. The model could include two different arcs with a lower bound of five and a upper bound of 10 on each of arc, a value of $1.00 on one arc and a value of a $1.30 on the other arc. In a similar manner arcs can be added to represent the possibility of deadheading (moving an empty truck) from A to B, typically at a negative profit.

The advantage of this dynamic model is that it incorporates changing market conditions when calculating values. That is, a given load may be undesirable today, but very desirable tomorrow due to changes in market demand and capacity. The dynamic model is valuable for day-to-day, operational decision making regarding issues such as spot pricing, load acceptance, and other applications described further below.

A simpler network flow model can also be used that does not have different nodes for different times, but only includes a single node for each location. This is called the “holistic” model. The holistic model is simpler because it doesn't take into account changing conditions over time. The holistic model provides a simpler, less computationally intensive model that can be useful as a scenario evaluator for decision making on contracted pricing and other long-term decision making. The disadvantage is that the holistic model does not take into account how the location values will vary over time based on fluctuations in capacity and demand. Both the holistic and dynamic models can be used not only for calculating the marginal value of a unit of capacity, but they also double as scenario testers to help answer a range of longer-term tactical and strategic questions.

3. Applications

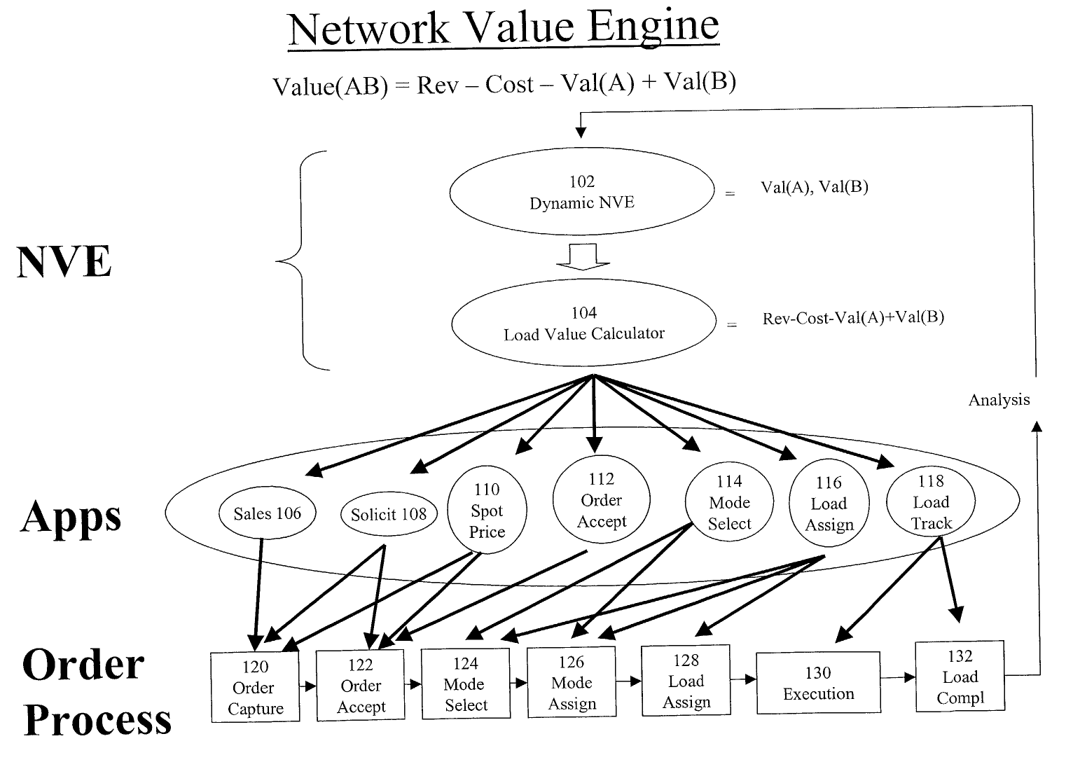

FIG. 1 depicts a block diagram illustrating how the dynamic and holistic models can be used in a number of example applications. Dynamic network value engine (NVE) 102 calculates the marginal value of a unit of capacity at a given location at a given time, Val(i), by solving the dual linear program of the dynamic model (described above). Dynamic NVE 102 thereby creates a matrix containing the calculated marginal values Val(i) for a unit of capacity at each location and each time increment. Dynamic NVE 102 calculates marginal values going into the future for a predetermined number of days (for example, 14 days). Dynamic NVE 102 periodically updates the matrix values by resolving the dual linear program. Dynamic value engine 102 thereby continually updates the matrix in the background. By periodically updating the matrix, Dynamic NVE 102 thereby updates the marginal values based on changing market conditions, where trucks are being sent, changes in demand and other network effects. Dynamic NVE 102 can be performed by any computer or other processor capable of performing the necessary computations with the required speed.

Load Value Calculator 104 calculates the profitability of transporting a given load from A to B according to the equation (described above): profitability=Revenue −Cost−Val (A)+Val (B). Load Value Calculator 104 obtains the marginal values Val(A) and Val(B) by pulling the appropriate number off of the matrix created and updated by Dynamic NVE 102. Thus, Load Value Calculator 104 provides the capability to quickly and accurately determine the profitability of a given load in real-time. The profitability determination produced by Load Value Calculator 104 can then be used by a number of useful applications, described below.

a. Sales Application 106

A carrier uses sales application 106 to sell large freight commitments for the next year. Typically a carrier will send a customer service representative (CSR) from the sales department to visit a shipper to capture large freight commitments for the next year. By using the profitability values determined by load value calculator 104, the CSR can first determine which freight shipments from which shippers are the most profitable. For example, the CSR may determine that Retailer A has a shipment from San Francisco to Denver that is highly profitable. This will prompt the CSR to make a visit to Retailer A to discuss a shipment contract for that particular lane.

The values calculated by load value calculator 104 also allow the CSR to determine what prices to offer for each shipment and what prices to accept. For example, the load value calculator 104 could provide to the CSR a range of prices and the potential profitability of the shipment at each price. The CSR can thus effectively use the data provided by load value calculator 104 to offer prices and accept prices for shipment contracts for freight for the next year at an optimal profit.

b. Solicit Application 108

Another application is solicit application 108. Solicit application 108 is used by the carrier when the carrier has unused capacity in a given region. For example, on a given day, a carrier might have 10 trucks that are sitting idle in a particular location. In this situation, the carrier will make calls to shippers in that region that have freight to be shipped in order to find freight for the idle trucks to ship.

In a given specified region, a carrier would like to determine the optimal shippers to solicit based on 1) which shippers are most likely to provide freight and 2) what is the value of the freight that the shippers will provide on the lanes. Solicit application 108 uses the values calculated by load value calculator 104 to generate a list prioritizing the value of various shipments from various shippers. A CSR can use this list to determine which shippers to call, what prices to offer, and what prices to accept. In other words, this list allows the CSR to pursue the most profitable loads in order of priority.

As one example, suppose a carrier has an idle truck in San Francisco. The CSR knows that shipper A has freight going from San Francisco to Los Angeles, and they also have freight that's going from San Francisco to Denver. The Load Value Calculator 104 calculates that the shipment from San Francisco to Los Angeles would be much more profitable than the shipment from San Francisco to Denver. The CSR could then use this information to solicit shipper A to make an offer to ship the freight that is going from San Francisco to Los Angeles.

c. Spot Price Application 110

In the spot price situation, a shipper calls a CSR at the carrier because the shipper has a load that he needs moved, for example, from Denver to Dallas. The shipper asks to find out the spot price rate of the carrier. For example, the shipper has freight that the shipper needs moved tomorrow, and the shipper inquires about the spot price rate for shipping that freight. The CSR at the carrier can then use spot price application 110 to determine a spot price. Spot price application 110 uses Load Value Calculator 104 to quickly determine a spot price rate which produces a sufficient profitability for the carrier.

d. Order Accept Application 112

Most of the carrier's shipments will typically not be spot pricing. Spot pricing usually involves shippers who have not previously done business with the carrier. Generally the carrier controls which freight it ships not through spot pricing, but through contracted rates. The carrier mostly deals with shippers using contracted rates. For example, on a particular day, shipper A might have six loads that it needs to move from Denver to Los Angeles. Shipper A has a contracted rate with carrier A. Shipper A calls carrier A with a request to ship the six loads. The carrier can decide whether or not it wants to take the loads at the contracted rate. If the carrier has capacity available, it can accept the loads. Carrier A, however, might decide that shipper B has a shipment which is more profitable. Order accept application 112 uses Load Value Engine 104 to determine which shipments from contracted shippers to accept Typically, order accept application 112 will accept orders from about one to fourteen days in the future.

e. Mode Select Application 114:

Mode select application 114 is an application that selects a “mode” for shipment of a particular load that the carrier has agreed to transport. The carrier has several different “modes” by which it can transport freight. Example modes include Solo, Team, Canadian, Rail, Regional and 3rd Party. Solo mode is the standard mode. Solo mode is a trucker with a truck and a trailer. Team mode is a team consisting of two drivers in a single truck. Regulations provide maximum time limits that drivers can drive without resting. In team mode, the truck can be kept driving for extended periods of time. The team is therefore more efficient, but is also more expensive.

Rail mode is where the driver picks up a trailer with a truck, shuttles the trailer to a rail yard, puts the trailer on a train, and the train takes it across the country close to its destination. The trailer is then picked up at the rail yard by another truck and shuttled to its final destination.

Canadian mode is a truck with a Canadian driver. Under a trade agreement between the U.S. and Canada, the regulations require that a Canadian driver cannot pickup a load in the U.S. and deliver that load within the U.S. Similarly, an American driver cannot pickup a load in Canada and deliver the load in Canada. However, a Canadian driver is allowed to pick up a load in the United States and deliver the load in Canada. Therefore, if the carrier has a load that's going, for example from Indianapolis to Toronto, then the carrier must decide whether to have a Canadian driver that's in the Indianapolis area take that load or whether to put a U.S. driver on that load and then have the U.S driver take a load out of Toronto back into the U.S.

Mode select application 114 uses load value calculator 104 to calculate the profitability of particular loads that the carrier has agreed to transport for each available mode. Mode select application 114 then selects the most profitable mode. Mode select application 114 performs this selection for all loads that the carrier has agreed to transport typically two to five days into the future.

f. Load Assign Application 116

The Load Assign Application 116 looks at all the loads that the carrier has committed to ship, typically over the next one or two days. Load Assign Application 116 then selects a particular driver and unit of capacity for each load. In other words, for a given load from A to B in a given mode, Load Assign Application 116 selects an appropriate driver and unit of capacity to take the load. When assigning a driver to the load, Load Assign Application 116 takes account of various factors such as eventually getting a driver back to his or her home and using a big enough truck to transport the load.

g. Load Track Application 118

Load Track application 118 tracks loads and the completion of execution of loads. Load Track application 118 tracks all of the data concerning the execution of the load. This data is then stored and fed back to dynamic NVE 102. This allows dynamic NVE 102 to constantly update its matrix of marginal values to update changing market conditions and network effects.

4. Order Process: Steps 120-132

The order process, comprised of steps 120-132, is the process of using the various applications to receive offers, decide which offers to accept, and assign modes and drivers to accepted loads.

Order capture step 120 is the process of capturing orders from either sales application 106, solicit application 108, or spot price application 110. Order capture 120 is simply the receiving of an offer to move freight moved from A to B for a specified price. After the order has been captured, then in order accept step 122, the decision is made whether or not to accept the offer. For example, shipper A may call the carrier and ask for the spot price to move a load in a particular lane. The carrier captures this order in step 120. Later that day, the carrier calls shipper A back and either accepts or rejects the offer in order accept step 122. A big company may send a list to the carrier of all the shipments they need shipped tomorrow. For example, it could list three hundred shipments. The carrier will use load value calculator 104 to determine which offers to accept in order accept step 122.

In mode select step 124, mode select application 114 is used to select the optimal mode for the loads that have been accepted by the carrier. In mode assign step 126, the optimal mode is assigned. For example, in mode assign step 126, a team can be assigned to ship a load tomorrow from A to B. Load assign step 128 assigns the actual drivers and trucks that will take particular loads. Note that steps 124, 126, and 128 can all take place prior to order acceptance in step 122. For example, the carrier might want to determine the profitability of various modes before accepting an order.

In execution step 130, the load is actually shipped. In load completion step 132, the customer is billed for the shipment and the tracking data from Load Track 118 is stored. As described above, the tracking data is used by dynamic NVE 102 to update its matrix to reflect changing network conditions. The data is also used to update demand forecasts.

5. Webcrawler Feature

A number of web sites on the World Wide Web currently feature business-to-business exchanges for freight. These web sites allow shippers to post loads that they need shipped. Carriers can then review these loads and decide whether to accept any offers to ship. Some of these exchanges allow the parties to make binding commitments using the web site. Other exchanges merely provide a phone number of the shipper or carrier, so that commitments can be made offline. The web site might also allow a carrier to search for loads meeting certain specifications. For example, the carrier could request to view all of the freight being shipped out of Chicago over the next week.

The system of the present invention illustrated in FIG. 1 can be used to implement a “webcrawler” feature. The webcrawler scans a business-to-business exchange database for shipping freight. The webcrawler uses load value calculator 104 to determine which loads are profitable, and which are the best loads to accept, if any. The loads that are highly profitable can immediately be grabbed. If the carrier has its own business-to-business database, the carrier can scan this database using the webcrawler.

The carrier could also use the webcrawler to scan other business-to-business exchange databases connected to the Internet (or any other network). A program which performs this type of mining of information from databases on the Internet is sometimes referred to as a “spider” or “bot.”

6. Conclusion

Although specific embodiments of the present invention have been described, it will be understood by those of skill in the art that there are other embodiments that are equivalent to the described embodiments. Accordingly it is to be understood that the invention is not to be limited by the specific illustrated embodiments, but only be the scope of the appended claims.

1. A method of managing transportation demand and capacity, comprising:
creating a network flow model comprised of a plurality of nodes, each node representing a specific location;
calculating the duals of a dual linear program based on the network flow model to determine the marginal value of a unit of capacity at a source node and the marginal value of a unit of capacity at a destination node;
calculating the value of transporting a load from the source node to a destination node based on the marginal values of a unit of capacity at the source node and destination node; and
making a transportation decision based on the calculated value of transporting the load.

2. The method of claim 1, wherein the network flow model is comprised of a plurality of nodes, each representing a specific location at a specific time.

3. The method of claim 2, wherein the source node and the destination node are connected by an arc, the arc having a variable associated with the arc, the variable representing a number of units of capacity to be moved between the source node and the destination node.

4. The method of claim 3, wherein the network flow model includes constraints at each node representing conservation of flow.

5. The method of claim 4, wherein the arc has an upper bound representing the demand for loads to be transported between the source node and the destination node, and the arc has a lower bound representing commitments for loads to be transported between the source node and the destination node.

6. The method of claim 5, further comprising:
forecasting the demand between the source node and the destination node based on historical data.

7. The method of claim 5, wherein the arc has an associated average revenue and average cost.

8. The method of claim 2, further comprising:
solving the dual of a linear program associated with the network flow model to determine the marginal value of a unit of capacity at the source node and the marginal value of a unit of capacity at the destination node.

9. The method of claim 2, wherein the source node and the destination node are connected by a plurality of arcs, each arc having an associated revenue and an associated cost.

10. The method of claim 2, further comprising:
creating a matrix containing the marginal value of a unit of capacity at each node in the network flow model up to a predetermined time in the future.

11. The method of claim 10, further comprising:
periodically updating the matrix values by resolving the duals of a linear program associated with the network flow model.

12. The method of claim 11, further comprising:
calculating the profitability of transporting a given load from A to B according to the equation: profitability=Revenue−Cost−Val (A)+Val (B), wherein Val(A) and Val(B) are the marginal value of a unit of capacity at location A and location B, respectively.

13. The method of claim 12, wherein the marginal values of a unit of capacity are obtained from the matrix.

14. The method of claim 13, further comprising:
using the profitability calculation to make at least one of the following transportation decisions:
a) deciding whether or not to accept an offer to transport a load at a specified contracted price over a specified time period;
b) prioritizing a plurality of offers to transport loads based on profitability;
c) determining a contracted price to offer for transporting a load;
d) determining a price to offer a shipper, for soliciting the shipper to transport a load by an idle unit of capacity;
e) determining a spot price for transporting a load;
f) selecting a mode of one of solo, team, rail, third party, regional or Canadian; and
g) assigning a specific unit of capacity and a specific driver to a particular load.

15. The method of claim 13, further comprising:
searching a database containing a plurality of offers to have loads shipped;
determining the profitability of each offer; and
prioritizing the offers based on profitability.

16. The method of claim 15, further comprising:
spidering a database connected to a network to search for offers.

17. The method of claim 1, wherein the transportation decision is used in a scenario evaluator.

18. A method of managing transportation demand and capacity, comprising:
creating a matrix containing the marginal value of a unit of capacity at each node in a network flow model up to a predetermined time in the future by solving the duals of a linear program associated with the network flow model;
periodically updating the marginal values in the matrix by resolving the duals of a linear program associated with the network flow model;
calculating the profitability of transporting a load based on the marginal value of a unit of a capacity at a source node and the marginal value of a unit of capacity at a destination node; and
making a transportation decision based on the profitability calculation.

19. A method of managing transportation demand and capacity, comprising:
calculating the marginal value of a unit of capacity at a source node and a destination node in a network flow model by solving the duals of a linear program associated with the network flow model;
calculating the profitability of transporting a load based on the marginal value of a unit of a capacity at the source node and the marginal value of a unit of capacity at the destination node; and
making a transportation decision based on the profitability calculation.
